(19) United States
(12) Patent Application Publication
(10) Pub. No.: US 2014/0172367 A1
(43) Pub. Date: Jun. 19, 2014

(54) INTERFERENCE CHECK APPARATUS AND METHOD

(71) Applicant: FUJITSU LIMITED, Kawasaki-shi (JP)

(72) Inventors: Yoshihito OKUWAKI, Kawasaki (JP); Kenji ISHIZUKA, Setagaya (JP); Akio SAKAMOTO, Kawasaki (JP); Youji UCHIKURA, Tachikawa (JP); Kazuhiko HAMAZOE, Kawasaki (JP); Yoshikazu ICHIKAWA, Yokohama (JP)

(73) Assignee: FUJITSU LIMITED, Kawasaki-shi (JP)

(21) Appl. No.: 14/044,897

(22) Filed: Oct. 3, 2013

(30) Foreign Application Priority Data
Dec. 17, 2012 (JP) 2012-274565

(51) Int. Cl. G06F 11/34

(52) U.S. Cl. CPC G06F 11/3409
USPC 702/182

(57) ABSTRACT

An interference check apparatus that includes: a memory configured to store a latest edit time stamp related to at least one of a profile or a position for each of the plurality of components, and to store an edit time stamp for each of the plurality of components at an interference check execution time and to store an interference check data representing an execution result of an interference check between components out of the plurality of components; and a processor configured to execute a procedure, the procedure comprising: determining a validity of the interference check data stored based on the latest edit time stamp of each of the plurality of components and the edit time stamp of components when the interference check is executed contained in the interference check data.

### CROSS-REFERENCE TO RELATED APPLICATION

This application is based upon and claims the benefit of priority of the prior Japanese Patent Application No. 2012-274565, filed on Dec. 17, 2012, the entire contents of which are incorporated herein by reference.

### FIELD

The embodiments discussed herein are related to an interference check apparatus, an interference check method and an interference check program.

### BACKGROUND

A Computer Aided Design (CAD) system is employed to perform design efficiently when designing products including plural components. In a CAD system, by designing individual components contained in a product, one component is designed from a combination of plural other components, and a product is designed from a combination of plural components. When designing a product containing plural components, consideration is given to component interference such as overlapping of component that are contained in a product with each other in a stationary state, and consideration is given, in a product containing components that move, to one component obstructing movement of another component. CAD systems are known that have a function to perform interference checks to check interference of components in order for a user to ascertain during product design which components interfere.

As an example of interference checks between components, technology is known that employs a CAD system, and during design of a product containing plural components the components that are to be the target for performing interference checks on are identified. As technology to identify the components to be the target for performing interference checks on, for example a check target region is set at the periphery of interference check target components. After setting the check target region, a target object is selected to be the target of an interference check with respect to the target component based on profile data of the interference check target region, and an interference check is performed using profile data of the target component and the target object.

Sometimes in interference checks of a product the processing time becomes long and the processing load is heavy, and so the re-use of interference check results is being investigated in order to shorten the processing time and reduce the processing burden. A known example of technology that re-uses interference check results is technology in which interference check results from interference checks executed in the past are used when performing interference checks on components in a product. For example, in such technology, for combinations of plural components, when interference checks have been performed in the past then the results of interference check performed in the past are output as interference check results related to the combinations of plural components.

### RELATED PATENT DOCUMENTS

Japanese Laid-Open Patent Publication No. 1994-60151

Japanese Laid-Open Patent Publication No. 2007-257082

### SUMMARY

According to an aspect of the embodiments, an interference check apparatus that includes: a memory configured to store a latest edit time stamp related to at least one of a profile or a position for each of the plurality of components, and to store an edit time stamp for each of the plurality of components at an interference check execution time and to store an interference check data representing an execution result of an interference check between components out of the plurality of components; and a processor configured to execute a procedure, the procedure includes: determining a validity of the interference check data stored based on the latest edit time stamp of each of the plurality of components and the edit time stamp of components when the interference check is executed contained in the interference check data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of an interference check apparatus according to a first exemplary embodiment;

FIG. 2 is a block diagram illustrating an example of a relationship between assemblies and parts of a product;

FIG. 3 is a diagram illustrating an example of a format of interference check result data;

FIG. 4 is a block diagram illustrating an example of an interference check apparatus implemented by a computer;

FIG. 5 is a flow chart illustrating a flow of operation of an interference check execution section;

FIG. 6 is a flow chart illustrating a flow of an assembly extraction process;

FIG. 7 is a diagram illustrating an example of an interference check result list;

FIG. 8 is an explanatory diagram illustrating an example of a procedure of rearrangement processing;

FIG. 9 is an explanatory diagram illustrating discrepancies between last edit times of an object;

FIG. 10 is a flow chart illustrating an example of flow in list update processing;

FIG. 11 is a diagram illustrating an example of higher assemblies to a target assembly;

FIG. 12 is a flow chart illustrating a flow of a check execution process and a data writing process;

FIG. 13 is an explanatory diagram illustrating an example of interference check results for a hierarchical structure of a product;

FIG. 14 is a diagram illustrating an example of interference check result data;

FIG. 15 is a diagram illustrating an example of interference check result data;

FIG. 16 is a flow chart illustrating a flow of processing in an interference check result output program;

FIG. 17 is a diagram illustrating an example of an interference check result list;

FIG. 18 is a diagram illustrating another example of an interference check result list;

FIG. 19 is a diagram illustrating an example of display data; and

FIG. 20 is an explanatory diagram illustrating an example of usage of a component according to a second exemplary embodiment.

### DESCRIPTION OF EMBODIMENTS

Detailed explanation follows regarding an exemplary embodiment of technology disclosed herein, with reference to the drawings.

### First Exemplary Embodiment

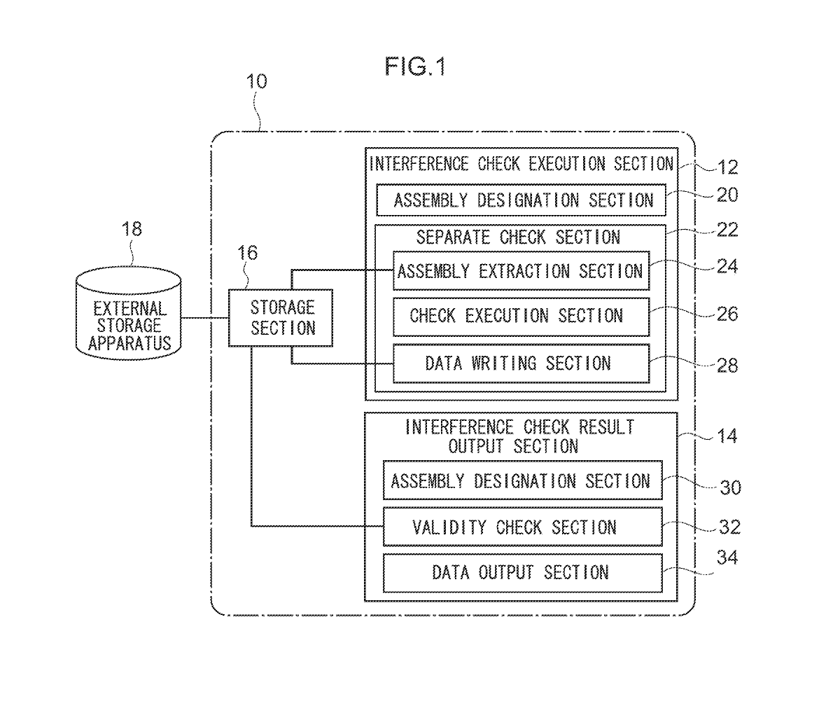

FIG. 1 illustrates a configuration of an interference check apparatus 10 according to a first exemplary embodiment. The interference check apparatus 10 includes an interference check execution section 12, an interference check result output section 14 and a storage section 16. The storage section 16 is connected to an external storage apparatus 18. Design data representing the structure of a product is stored in the external storage apparatus 18. A known example of design data is CAD data such as a wire-frame employed in a CAD program. For example, in a CAD program a product is associated with a numerical computation model used in numerical computation by using design data such as a wire-frame, and the numerical computation model is employed to aid the structural design of the product.

A product generally includes an assembly body combining plural components. Moreover, an assembly body is also sometimes part of a higher level assembly body. In the present exemplary embodiment, the product is the highest level assembly body, and explanation follows regarding an example of a multi-layered structure that, on progression from the highest level to the lowest level includes at least an assembly body and/or a component that is part of a higher assembly body, and wherein components correspond to the lowest level. Note that in the first exemplary embodiment the assembled bodies are referred to collectively as assemblies, and components are referred to collectively as parts. Moreover, assemblies and parts that are subordinate to a given assembly are referred to collectively as objects. Namely, object(s) of a given assembly include at least one assembly or part at one level below.

The storage section 16 contained in the interference check apparatus 10 temporarily stores design data of a product subject to an interference check out of product design data stored in the external storage apparatus 18. The storage section 16 stores interference check result data. Note that in the following detailed explanation interference check result data is associated as attribute data with the assembly represented by the design data.

The interference check execution section 12 contained in the interference check apparatus 10 includes an assembly designation section 20 and an separate check section 22. The separate check section 22 includes an assembly extraction section 24, a check execution section 26 and a data writing section 28. The interference check result output section 14 includes an assembly designation section 30, a validity check section 32 and a data output section 34. The assembly extraction section 24 and the data writing section 28 of the separate check section 22 are connected to the storage section 16. The validity check section 32 of the interference check result output section 14 is connected to the storage section 16.

For a product that is an interference check target, the interference check execution section 12 checks for interference of components, such as overlapping parts of components contained in the product, or interference of one component with another component of the product accompanying movement. The assembly designation section 20 contained in the interference check execution section 12 designates the highest level assembly for executing interference checks. The separate check section 22 contained in the interference check execution section 12 executes the interference checks for assemblies and parts that are subordinate to the highest level assembly designated by the assembly designation section 20. The assembly extraction section 24 contained in the separate check section 22 extracts a new assembly for executing interference checks on for each of the assemblies subordinate to the highest level assembly. The check execution section 26 executes interference checks between at least one assembly and/or part that is a subordinate object to each of the assemblies that have been extracted by the assembly extraction section 24 for executing a new interference check on. The data writing section 28 associates the result of the interference check executed by the check execution section 26 with each of the assemblies and stores these as interference check data in the storage section 16. Namely, the data writing section 28 associates the interference check results obtained by executing interference checks in the check execution section 26 with each of the assemblies on which interference checks are executed, and stores the associated interference check results in the storage section 16.

The interference check result output section 14 contained in the interference check apparatus 10 includes the assembly designation section 30, the validity check section 32 and the data output section 34. The assembly designation section 30 designates the highest level assembly for which to output interference check results. The validity check section 32 acquires the interference check result data associated with each of the assemblies subordinate to the highest level assembly designated by the assembly designation section 30, and determines whether or not the acquired interference result data is valid or not. The data output section 34 outputs interference result data for all the assemblies subordinate to the highest level assembly.

The design data stored in the external storage apparatus 18 contains data for each of configuration data, position data, profile data and last edit time data. The configuration data is data representing the configuration of assemblies and parts contained in each of the assemblies. An example of configuration data is a list of identification data for identifying the assemblies and parts that are objects subordinate to a given assembly. The configuration data also contains data representing the hierarchical relationship from assembly to parts. The positional data is data representing the position of assemblies and parts contained in each of the assemblies. The profile data is data representing the profile of each of the parts.

Note that the last edit time data indicates the last edit time of an assembly or part edited by CAD. Namely, the last edit time data indicates the last time the assembly or part is edited. In a CAD system, specific examples of last edit times are time stamps at the time of execution of a command to perform a profile change on a part or a command related to placement and position of a part or assembly, or a time stamp at the point in time when the editing of the command is confirmed. The last edit time is appended to each object as object level attribute data such as attribute parameters. Known examples of commands to perform a change of profile on a part are commands to perform solid geometry generation and editing (generation such as projection, cutting, rounding, and dimension criterion and dimension editing). Specific examples of known assembly placement and positioning commands are commands representing placement coordinate designations and restriction conditions (sometimes referred to as link conditions).

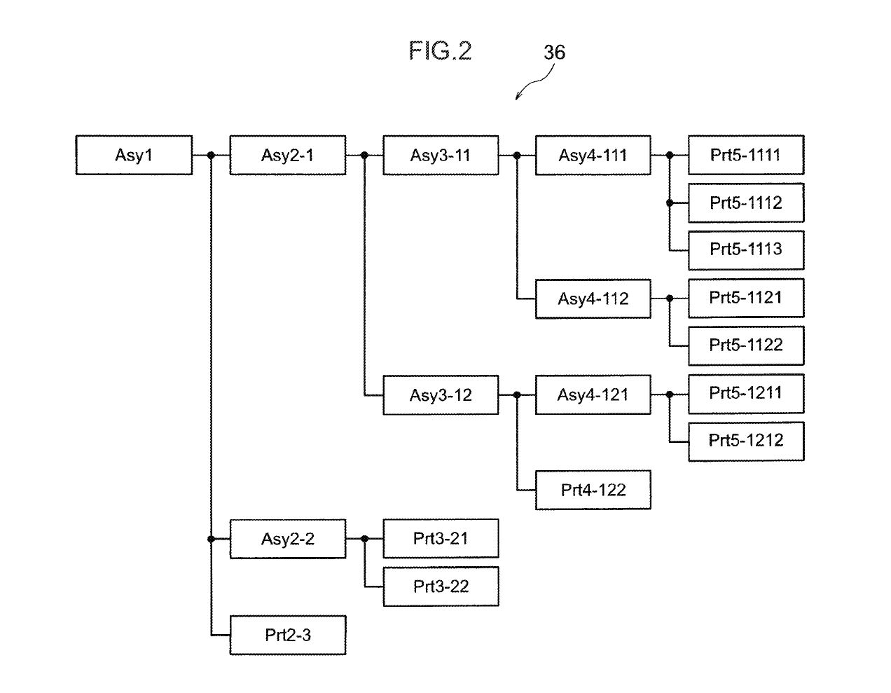

FIG. 2 illustrates an example of a relationship between assemblies and parts of a product in design data. FIG. 2 illustrates a hierarchical structure 36 of a product in a case in which there is a hierarchical relationship between assemblies and parts in a product. In FIG. 2, the label Asy indicates an assembly, and the label Prt indicates a part. Moreover, the labels for the assemblies and parts in the product are followed by numerical data representing the positional relationship between the assemblies and parts. Note that the numerical data is a numerical value corresponding to the hierarchical position of the assembly or part in the product, and a numerical value string representing the sequential position of objects that are subordinate to higher level assembly, linked together with a hyphen. For example, an assembly in the first layer that is the highest rank is represented by Asy1, assemblies that are in the second layer subordinate thereto are represented by Asy2-1, Asy2-2, and a part therein by Prt2-3. The assemblies in the third layer are represented by Asy3-11, Asy3-12, and parts therein by Prt3-21 and Prt3-22.

The interference check result data contains object data containing the last edit time and the interference result data indicating the interference check result. In the first exemplary embodiment, the interference check result data is associated with each of the assemblies contained in the product, and the associated data is stored in the storage section 16. The object data has the objects, namely assemblies and parts, that were subordinate to the subject assembly when the interference check is performed, and the objects are respectively associated with the last edit time of each of the objects. The interference result data indicates the latest interference check results out of interference check results from interference checks executed under instruction from a user. Note that although explanation has been given of a case in which interference check result data is stored in the storage section 16, configuration may be made such that interference check result data is stored on, and read from, the external storage apparatus 18.

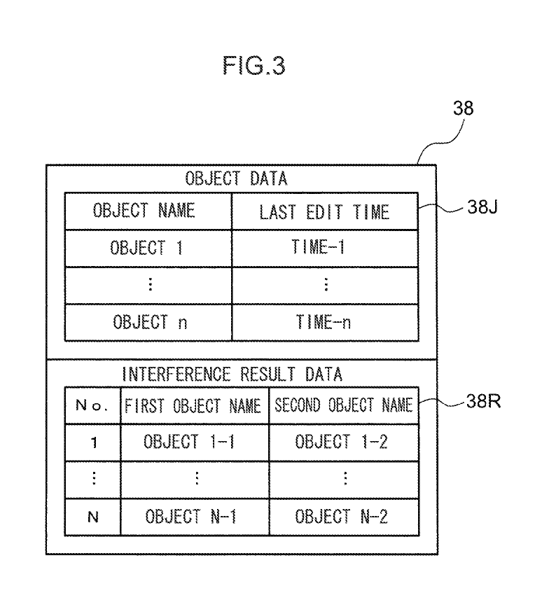

FIG. 3 illustrates an example of a format of interference check result data. The interference check result data 38 contains the object data 38J and the interference result data 38R. The object data 38J is stored with object names that represent the objects that are subordinate to the assembly associated with the interference check result data 38, and the object names are associated with the last edit time of the objects and stored. The interference result data 38R is stored with first object names indicating each of the objects contained in the object data 38J, associated with second object names indicating other objects that interfere with the first objects. Note that the interference result data 38R may be a list of all the objects contained in the object data 38J, or the interference result data 38R may be a list of only those objects found to interfere as a result of executing the interference checks. When the interference result data 38R is a list containing all the objects contained in the object data 38J, it is possible to identify first objects that are found as a result of executing the interference checks to have no interference by recording second object names using a specific format, such as an empty cell.

Note that the interference check apparatus 10 serves as an example of an interference check apparatus of technology disclosed herein. The storage section 16 is an example of a storage section of technology disclosed herein, and the validity check section 32 is an example of a determination section of technology disclosed herein. The interference check result data is an example of interference check data of technology disclosed herein.

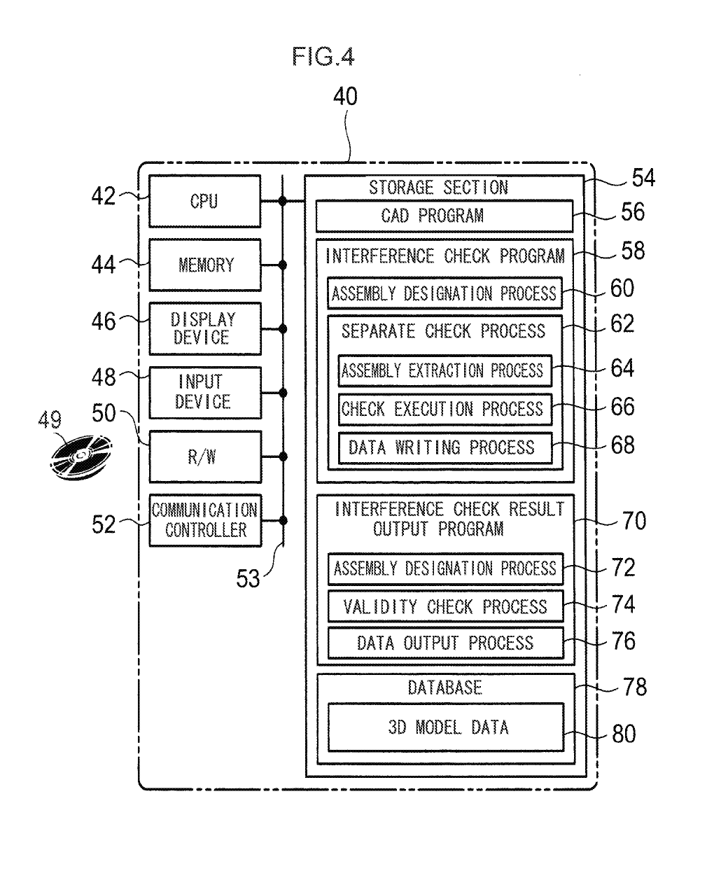

FIG. 4 illustrates an example when the interference check apparatus 10 is executed by a computer. The interference check apparatus 10 illustrated in FIG. 1 is implemented by a computer 40. The computer 40 includes a CPU 42, a memory 44 and a non-volatile storage section 54. The CPU 42, the memory 44 and the non-volatile storage section 54 are connected together through a bus 53. The storage section 54 may be implemented for example by a Hard Disk Drive (HDD) or flash memory. Moreover, the computer 40 includes a communication controller 52 for connecting to a network, and the communication controller 52 is connected to the bus 53. The computer 40 also includes a display device 46 that serves as an example of an output device, and an input device 48 such as a keyboard and mouse that serves as an example of an input device. The display device 46 and the input device 48 are connected to the bus 53. The computer 40 also includes a device (R/W device) 50 into which a recording medium 49 such as an optical disk is inserted, and that reads from and writes to the recording medium 49. The R/W device 50 is connected to the bus 53. Note that the display device 46, the input device 48, the R/W device 50 may be omitted, and may or may not be connected to the bus 53 as required.

A CAD program 56 is stored in the storage section 54, and the computer 40 operates as a CAD apparatus when the CPU 42 executes the CAD program 56. Note that since specific principle functions of a CAD apparatus implemented by the CAD program 56 are not directly relevant to the first exemplary embodiment explanation thereof is omitted.

The storage section 54 is also stored with an interference check program 58 and an interference check result output program 70. The interference check program 58 includes an assembly designation process 60 and a separate check process 62. The separate check process 62 includes an assembly extraction process 64, a check execution process 66 and a data writing process 68. The interference check result output program 70 includes an assembly designation process 72, a validity check process 74 and a data output process 76. A database 78 including product design data and interference check result data is stored in the storage section 54. Note that in FIG. 4 the data including product design data and interference check result data is represented by 3D model data 80.

The interference check program 58 and the interference check result output program 70 are each read from the storage section 54, expanded in the memory 44, and executed by the CPU 42. Namely, the interference check apparatus 10 is implemented by the computer 40, and the computer 40 operates as the interference check execution section 12 illustrated in FIG. 1 by the CPU 42 executing the interference check program 58. The computer 40 operates as the interference check result output section 14 illustrated in FIG. 1 by the CPU 42 executing the interference check result output program 70.

Moreover, in the computer 40 implementing the interference check apparatus 10, the CPU 42 operates as an example of the assembly designation section 20 illustrated in FIG. 1 by executing the assembly designation process 60 contained in the interference check program 58. The CPU 42 also operates as an example of the separate check process 62 illustrated in FIG. 1 by executing the separate check process 62 contained in the interference check program 58. Note that the CPU 42 operates as respective examples of the assembly extraction section 24, the check execution section 26 and the data writing section 28 illustrated in FIG. 1 by respectively executing the assembly extraction process 64, the check execution process 66 and the data writing process 68 contained in the separate check process 62.

Moreover, in the computer 40 implementing the interference check apparatus 10, the CPU 42 operates as an example of the assembly designation section 30 illustrated in FIG. 1 by executing the assembly designation process 72 contained in the interference check result output program 70. The CPU 42 operates as respective examples of the validity check section 32 and the data output section 34 illustrated in FIG. 1 by respectively executing the validity check process 74 and the data output process 76 contained in the interference check result output program 70.

Note that the interference check program 58 and the interference check result output program 70 executed by the computer 40 are examples of the interference check program of technology disclosed herein. The interference check program 58 and the interference check result output program 70 executed by the computer 40 are programs that cause the computer 40 to function as the interference check apparatus of technology disclosed herein. Moreover, a recording medium such as an optical disk recorded with programs that cause the computer 40 to execute processing is also an example of a recording medium of technology disclosed herein.

Explanation follows regarding operation of the first exemplary embodiment.

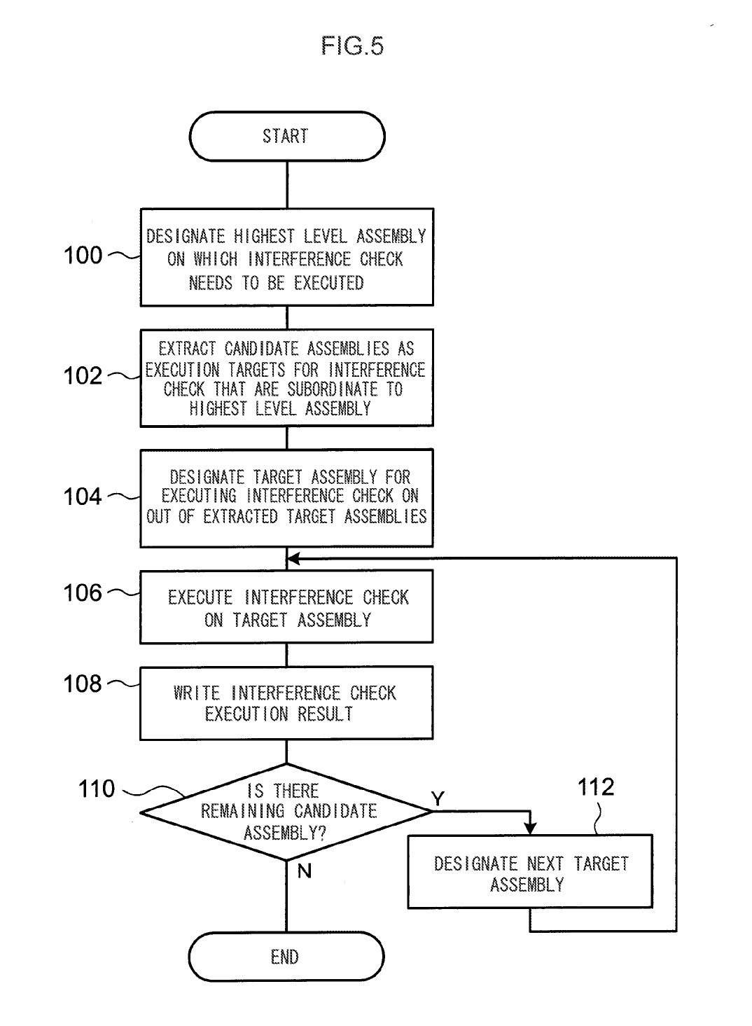

FIG. 5 illustrates a flow in operation of the interference check execution section 12 contained in the interference check apparatus 10 implemented by the computer 40 (FIG. 2). Namely, FIG. 5 illustrates the flow of processing of the interference check program 58 (FIG. 4).

Note that in the first exemplary embodiment, a case is considered in which product design-assistance is executed as a CAD apparatus, design data for the product subject to design-assistance is stored in the storage section 16 in the interference check apparatus 10, and interference check result data is also stored up the previous time. Namely, the CAD program 56 is executed by the CPU 42, and data including the design data for the product subject to design-assistance and interference check result data up to the previous time, is stored as the 3D model data 80 in the database 78 of the storage section 54.

When a user interference check start instruction is received by the input device 48, the CPU 42 of the computer 40 executes the processing routine illustrated in FIG. 5 as an assembly designation process 60, and processing of steps 100 onwards is executed. At step 100, the highest level assembly on which to execute an interference check is designated. At step 100, the designation is read in of the assembly designated by a user using the input device 48 to be subject to interference check, and the read assembly is designated as the highest level assembly. The CPU 42 executes the separate check process 62 on the designated highest level assembly. Specifically, first at step 102, out of each of the assemblies subordinate to the highest level assembly designated at step 100, the assembly extraction process 64 is executed to extract candidate assemblies as assemblies for performing a new interference check on.

The CPU 42 then executes an interference check between the objects subordinate to each of the assemblies extracted for new interference checks at step 102. Interference check result data is associated with each of the assemblies (attribute data writing), and the 3D model data 80 is stored in the database 78.

More specifically, at step 104, an arbitrary assembly for executing interference checks is designated as the target assembly out of the candidate assemblies extracted at step 102. The priority sequence of the target assemblies designated at step 104 may be for example designation from the higher level in the hierarchical structure, and then in object sequence. At the next step 106, an interference check is executed for the target assembly designated at step 104, then at step 108 the interference check result data is associated with the target assembly, and stored in the database 78. That at step 110, out of the candidate assemblies extracted at step 102, determination is made as to whether or not there is a candidate assembly on which an interference check has not yet been executed at step 106. Negative determination is made at step 110 when an interference check has be completed for all the candidate assemblies extracted at step 102, and the present routine is ended. However, affirmative determination is made at step 110 when there is out of the candidate assemblies extracted at step 102, a candidate assembly remaining on which an interference check has not yet been executed, and processing proceeds to step 112. At step 112, the one of the candidate assemblies that has not yet completed interference checking is designated as the target assembly, and the processing returns to step 106.

Note that the processing of step 100 is an example of processing of the assembly designation section 20 illustrated in FIG. 1. Moreover, the processing of steps 102 to 112 are examples of processing in the separate check section 22 illustrated in FIG. 1. The processing of step 102 is an example of processing of the assembly extraction section 24 illustrated in FIG. 1, the processing of step 106 is an example of processing in the check execution section 26 illustrated in FIG. 1, and the processing of step 108 is an example of processing in the data writing section 28 illustrated in FIG. 1.

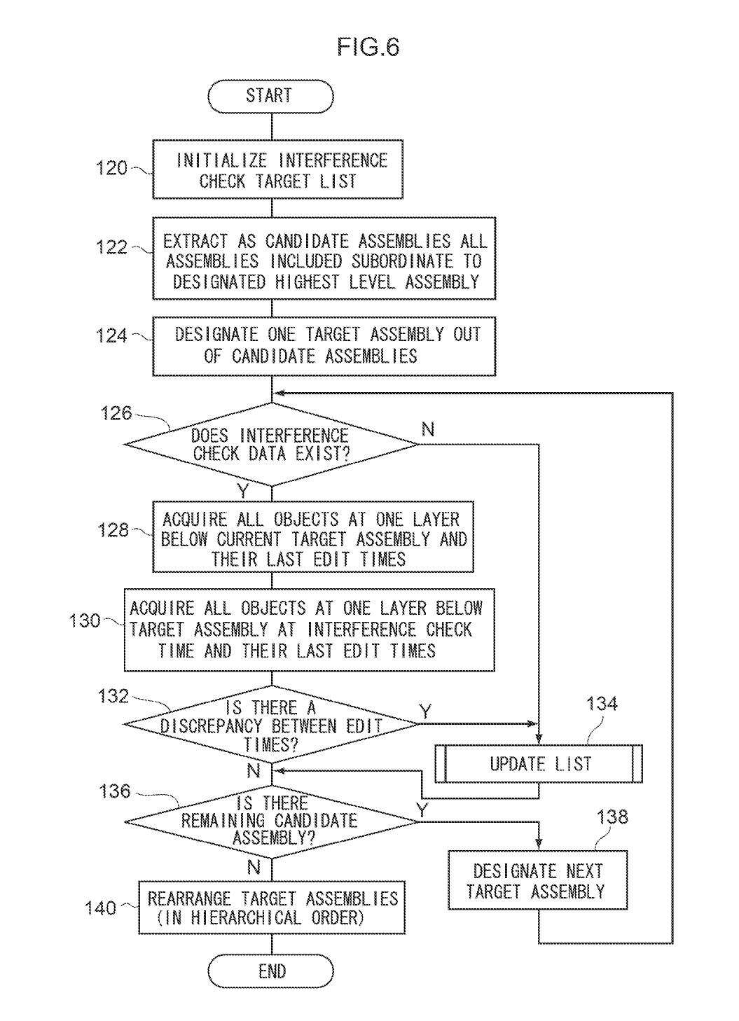

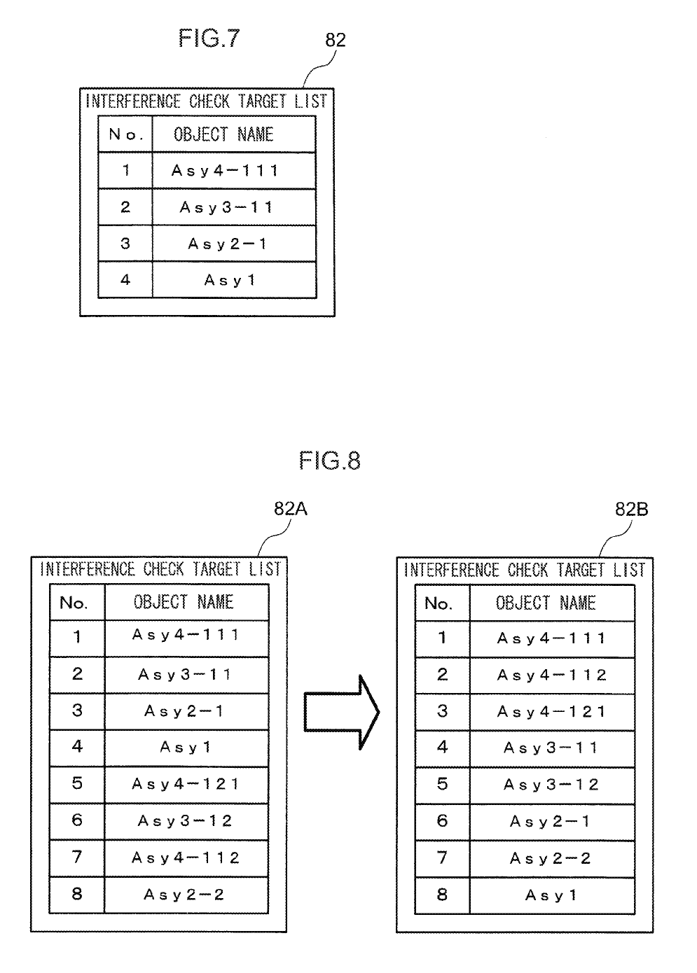

Explanation next follows regarding processing of steps 102 to 112 illustrated in FIG. 5 (processing of the separate check process 62). FIG. 6 illustrates a flow of the assembly extraction process 64 as the processing of step 102 of FIG. 5. The CPU 42 initializes an interference check target list 82 (FIG. 7) at step 120. The interference check target list 82 is recorded with assemblies on which to actually execute an interference check. Note that in the first exemplary embodiment, the interference check target list 82 is generated at step 120, and temporarily stored in the memory 44. Note that configuration may be made such that the interference check target list 82 is pre-stored in the database 78, and then at step 120 processing is executed to delete all of the assemblies from the interference check target list, thereby executing the initialization processing.

FIG. 7 illustrates an example of the interference check target list 82. The interference check target list 82 illustrated in FIG. 7 is an example stored with 4 assemblies as assemblies on which the execute the interference check, the Asy4-111, the Asy3-11, the Asy2-1 and the Asy1.

At step 122 illustrated in FIG. 6, all of the assemblies subordinate to the highest level assembly designated by the processing of step 100 illustrated in FIG. 5 are extracted as candidate assemblies. At the next step 124, one candidate assembly out of the candidate assemblies extracted at step 122 is designated as the target assembly. At the next step 126, determination is made as to whether or not there is already interference check result data for the target assembly designated as the interference check execution target. In the first exemplary embodiment, the interference check result data is associated as attribute data with each of the assemblies. Hence configuration may be made such that at step 126 determination is made as to whether or not there is already interference check result data as attribute data of the assembly. Note that in the first exemplary embodiment determination is made as to whether or not of the presence or absence of interference check result data, however data indicating that interference check result data is negative (no interference) may be stored as interference check result data when the interference check result data is negative. In such cases configuration may be made such that determination is made as to whether or not the data stored as the interference check result data is the data indicating the interference check result data is negative.

When negative determination is made at step 126, then interference check target list 82 update processing is executed at step 134, as described in detail later, and then processing proceeds to the processing of step 136. The list update processing is processing in which the assembly for executing an interference check on is added to update the interference check target list 82. Namely, when there is no interference check result data present for the target assembly designated as the interference check execution target, then at step 134 the target assembly is added to the interference check target list 82 so that an interference check will be performed for the target assembly.

However, when affirmative determination is made at step 126, then determination is made as to whether or not to execute an interference check on the target assembly. Namely, when there is already interference check result data for the target assembly, then at step 128, the object data (object name and last edit time) are acquired for all the objects that are 1 level subordinate to the target assembly at the current point in time. At step 128, the most recent object data is acquired based on the design data. At the next step 130, the object data (object name and last edit time) are acquired for all the objects that were 1 level subordinate to the target assembly at an interference check time. At step 130, object data is acquired based on the assembly attribute data associated at the interference check time. Then at step 132, determination is made as to whether or not there is a discrepancy between the last edit time acquired at step 128 and the last edit time acquired at step 130.

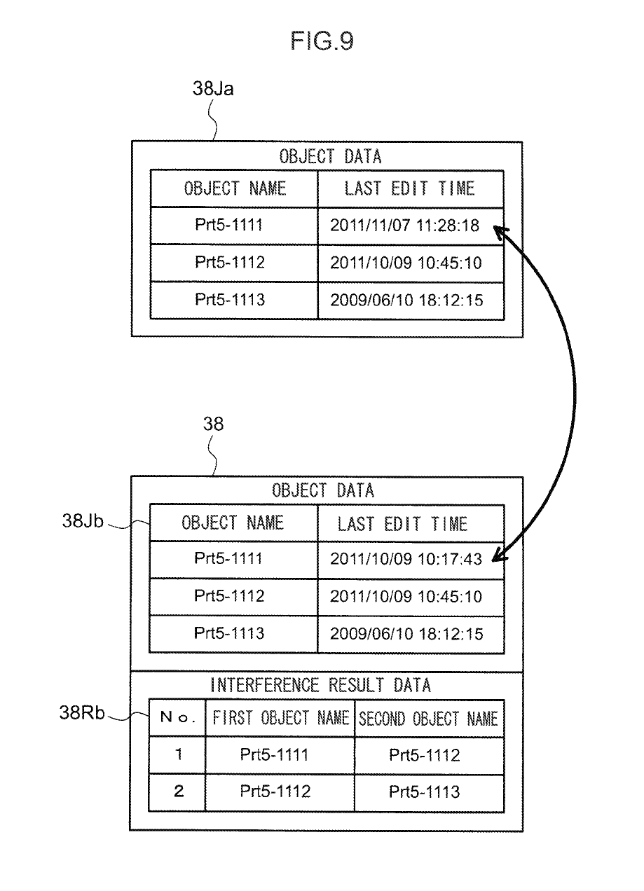

FIG. 9 illustrates discrepancies between the most recent last edit time based on the design data and the last edit time based on the attribute data at the interference check time. FIG. 9 illustrates an example in which only the profile of the Prt5-1111 subordinate to the assembly Asy4-111 has been changed since executing the interference check the previous time. There is a discrepancy between the times of the most recent object data 38Ja based on the design data: “2011/11/07 11:28:18”, and the most recent object data 38Jb based on the attribute data of the assembly at the interference check time: “2011/10/09 10:17:43”. Therefore since there is a discrepancy in the last edit time for the Prt5-1111 that is an object one level subordinate to the Asy4-111, the Asy4-111 becomes a target assembly for an interference check.

Affirmative determination is made at step 132 when there is a discrepancy between the most recent last edit time based on the design data and the last edit time based on the attribute data at the interference check time, and the target assembly is added to the interference check target list 82 at step 134. However, negative determination is made at step 132 when the most recent last edit time based on the design data matches the last edit time based on the attribute data at the interference check time, and processing proceeds to step 136 where processing is performed on the next remaining assembly. Namely, when the most recent last edit time based on the design data matches the last edit time based on the attribute data at the interference check time, since that object has not been edited since last executing an interference check the results of executing an interference check would be the same. Consequently, when negative determination is made at step 132, the update processing of the interference check target list 82 is not executed, and processing proceeds to step 136.

At step 136, determination is made as to whether or not there is a remaining candidate assembly for which interference check execution determination processing (step 126 to step 134) has not yet been completed. Negative determination is made at step 136 when interference check execution determination processing has already been completed for all candidate assemblies, then after executing processing at step 140 to rearrange the assemblies in hierarchical sequence, the current routine is then ended. At step 140, the processing at step 140 is processing to rearrange the order of the target assemblies in the interference check target list 82 in hierarchical sequence. However, when affirmative determination is made at step 136, then the next target assembly is designated at step 138, and processing proceeds to the processing of step 126.

FIG. 8 illustrates an example of a procedure for rearrangement processing as the processing of step 140. FIG. 8 is an example in which reordering is made from the unsystematically ordered interference check target list 82A to which the target assembly has been added, to given the target assemblies reordered from the deepest level assembly (Asy4-111) to the shallowest level assembly (Asy1).

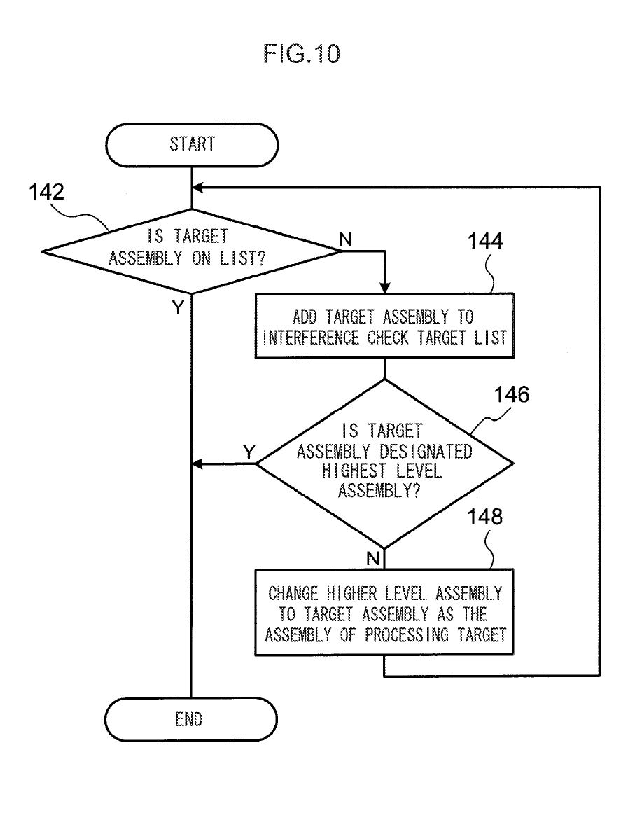

FIG. 10 illustrates a flow of list update processing as the processing of step 134 of FIG. 6. The CPU 42 determines at step 142 whether or not the target assembly has been recorded in the interference check target list 82, and the current routine is ended when affirmative determination is made.

However, when negative determination is made at step 142, the target assembly is added to the interference check target list 82 at step 144. At the next step 146, the determination is made as to whether or not the target assembly is the highest level assembly (designated at step 100 of FIG. 5), and the current routine is ended when affirmative determination is made. However, when the target assembly is not the highest level assembly (negative determination at step 146), then an assembly at a higher level than the target assembly is changed to being the target assembly, and processing returns to the processing of step 142. Note that when the target assembly is the target of interference check, the processing of step 146 and step 148 is preferably also executed with the assembly at a higher level thereto as the target assembly for interference checks, since the subordinate object data has changed.

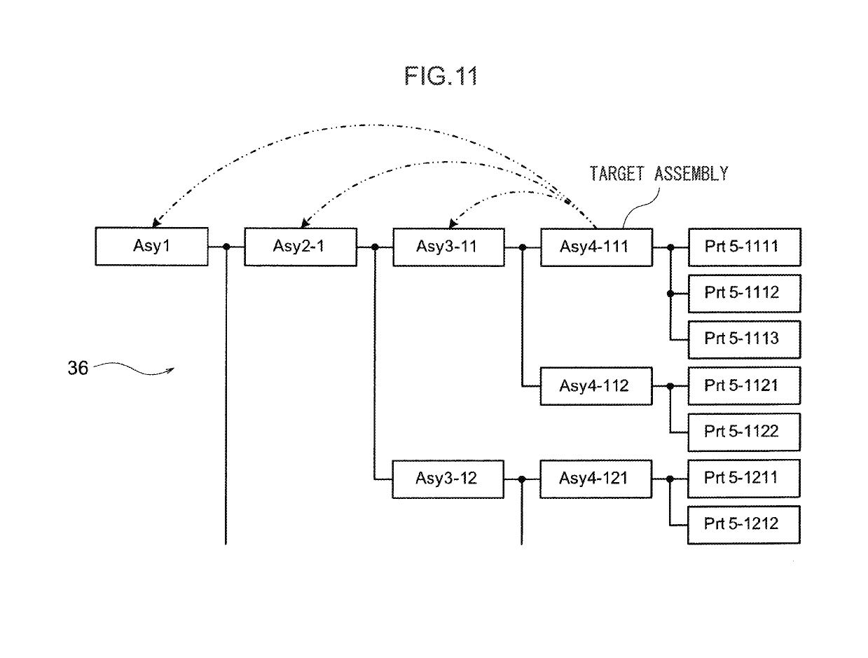

FIG. 11 is illustrates an example in which the assembly above the target assembly is made the interference check target assembly by the processing of step 146 and step 148. FIG. 11 illustrates a case in which, when the target assembly is Asy4-111, a higher assembly above the target assembly is changed to the target assembly as the higher assembly of Asy3-11, Asy2-1 as far as Asy1.

Namely, higher assemblies than the assembly Asy4-111 that includes the edited subordinate object of the part Prt5-1111, these being the assemblies Asy3-11, Asy2-1, Asy1, also contain the subordinate object (part Prt5-1111) that has been changed. Consequently, the higher assemblies to the assembly Asy4-111, these being assemblies Asy3-11, Asy2-1, Asy1, are added as target assembly for interference checks to the interference check target list 82. Note that the assemblies that are already recorded in the interference check target list 82 are not added anew.

Explanation next follows regarding processing of steps 104 to 112 of FIG. 5 (the check execution process 66 and the data writing process 68).

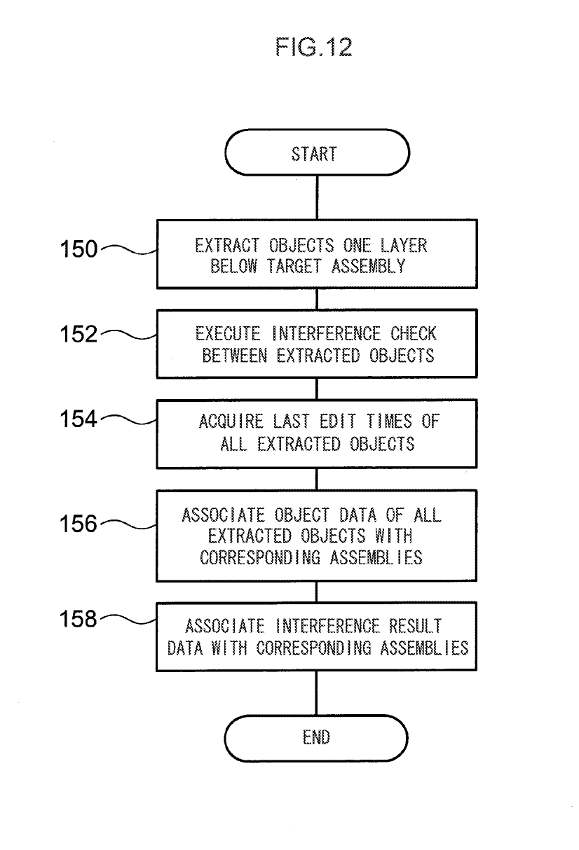

FIG. 12 illustrates a flow of the check execution process 66 as the processing of step 106 and of the data writing process 68 as the processing of step 108 as illustrated in FIG. 5. The check execution process 66 and the data writing process 68 execute interference checks for the designated target assembly out of the extracted candidate assemblies, and write the interference check result data as attribute data of the target assembly.

At step 150, the CPU 42 takes one of the assemblies of the interference check target list 82 and extracts objects one level below the target assembly, and at step 152 executes interference checks between the extracted objects. At the next step 154, the last edit time of all of the extracted objects is acquired. At the next step 156, the object data 38J of all of the extracted objects is associated with the corresponding target assemblies, and at the next step 158 the interference result data 38R is associated with the corresponding target assemblies. The processing to associate the object data 38J and the interference result data 38R with the corresponding target assemblies is processing to associate the interference check result data 38 with the target assembly and store these in the database 78.

Note that the processing of step 150 and step 152 corresponds to the processing of the check execution process 66, and the processing of step 154 to step 158 corresponds to the processing of the data writing process 68.

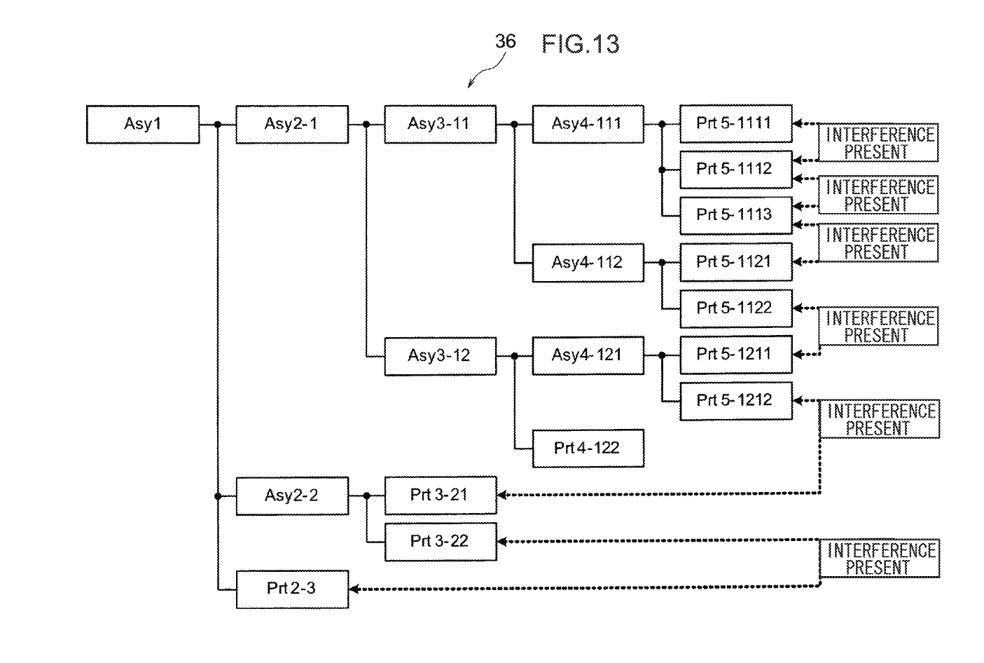

FIG. 13 illustrates an example of interference check results between the objects in the product hierarchical structure 36. FIG. 13 represents interference check results relating to the target assembly Asy1 associated with objects in the hierarchical structure 36.

The interference check execution is performed between objects one layer below the assembly Asy1 (between the assembly Asy2-1, Asy2-2, and the part Prt2-3). Namely, interference checks are performed between the assembly Asy2-1 and the assembly Asy2-2, the assembly Asy2-1 and the part Prt2-3, and the assembly Asy2-2 and the part Prt2-3. For example, when there is interference between the Prt5-1212 and the Prt3-21, a result is obtained for the interference check between the assembly Asy2-1 and assembly Asy2-2 that there is interference between the Prt5-1212 and the part Prt3-21 is obtained.

Moreover, as another example, when the target assembly is the assembly Asy4-111, interference checks are performed between the part Prt5-1111, the part Prt5-1112, and the part Prt5-1113 that are one layer subordinate to the assembly Asy4-111. FIG. 13 illustrates an example of results obtained indicating that there is interference between the part Prt5-1111 and the part Prt5-1112, and between the part Prt5-1112 and the part Prt5-1113.

Note that interference check processing between objects may be performed by using a function contained in CAD.

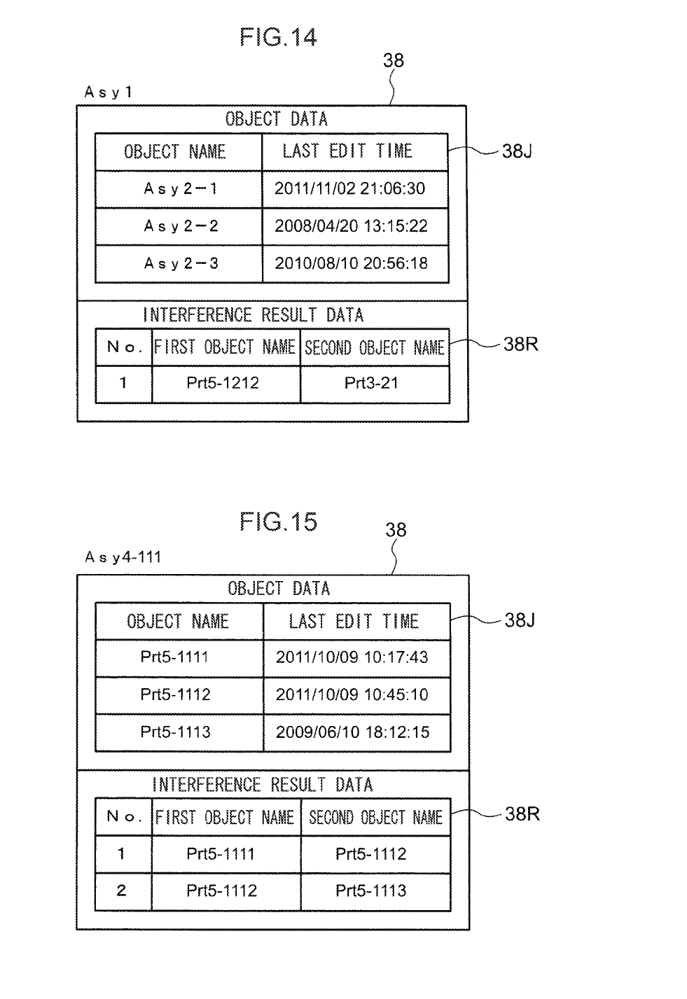

FIG. 14 and FIG. 15 illustrate examples of the interference check result data 38. FIG. 14 illustrates a case when the assembly Asy1 is the target assembly, and FIG. 15 illustrates a case in which the assembly Asy4-111 is the target assembly.

During execution of the interference check on the target assembly, the data indicating all objects (assemblies, parts) one layer below the target assembly in the hierarchical structure 36, and data of the last edit data of each of the objects can be obtained. Hence, the object data 38J can be obtained from data representing the objects and from last edit data of each of the objects. Note that the last edit data of the objects includes the profile and position of the objects, and the time the interference result data is edited. Moreover, it is possible to obtaining the results of interference checks executed between each of the objects 1 level subordinate to the target assembly by the processing of the interference check executed between objects (step 152). This enables the result of interference checks executed between each of the objects 1 level subordinate to the target assembly to be obtained as the interference result data 38R.

Note that the object data 38J includes an ID used in a general CAD system, namely includes various data enabling identification of an object and representing an object, and object ID data allocated at the object unit level may be employed. Moreover, the interference check result data 38 may employ a function in a CAD system to allocate attribute data to objects and for writing.

Note that the interference check result data is also preferably written to the assembly when there is no interference present. A good way to discriminate as to whether there an interference check has not been performed or a result of no interference is obtained when an interference check is executed is to write the interference check result data to the assembly when there is no interference.

Explanation next follows regarding operation of the interference check result output section 14 contained in the interference check apparatus 10. The interference check apparatus 10 is implemented by the computer 40 (FIG. 2), and the computer 40 operates as the interference check result output section 14 by executing the interference check result output program 70.

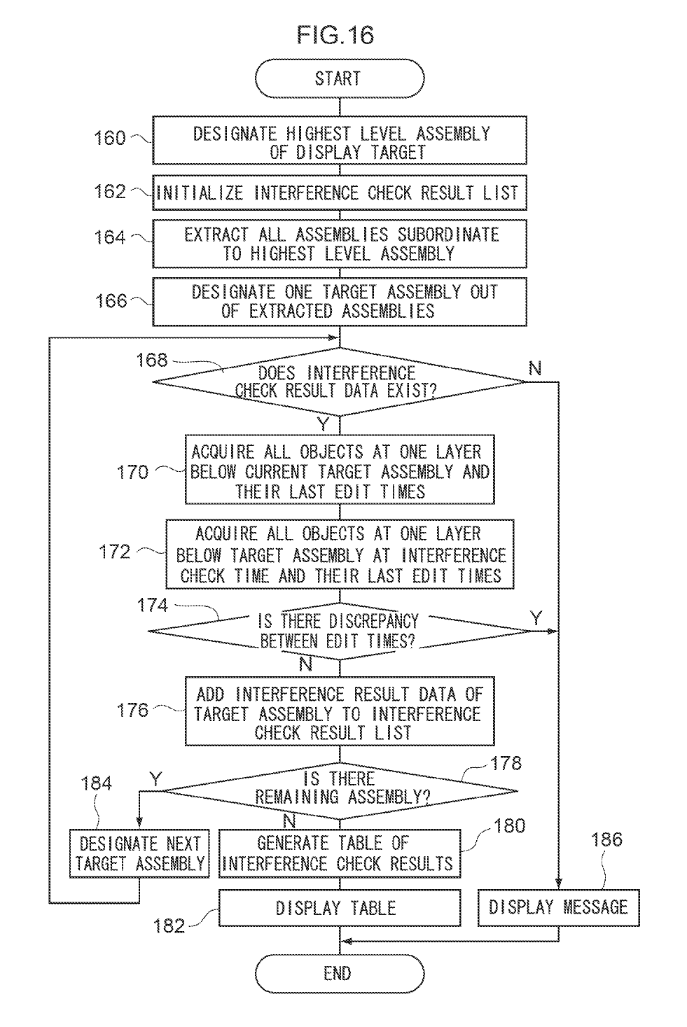

FIG. 16 illustrates a flow of processing of the interference check result output program 70. The interference check result output program 70 determines the validity of interference result data written to each of the assemblies subordinate to the designated highest level assembly, and executes processing to output the interference check result of subordinate assemblies whose interference result data is valid. Note that in the first exemplary embodiment an example is given of an interference check displayed as an interference check result output.

On receipt with the input device 48 of a user interference check result output instruction, the CPU 42 of the computer 40 executes the processing routine illustrated in FIG. 16, and executes the processing from step 160 onwards. At step 160, the highest level assembly on the interference check result display is designated as the assembly that is to be the interference check result output target. At step 160, designation of the assembly designated by a user with the input device 48 is read, and the read assembly is designated as the highest level assembly.

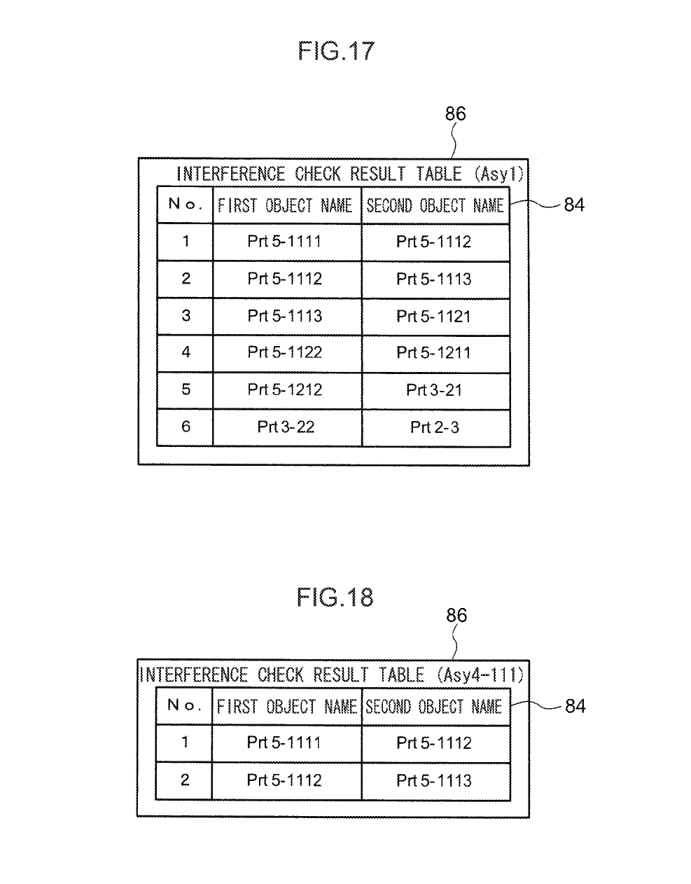

At step 162, the CPU 42 initializes an interference check result list 84 (FIG. 17). The interference check result list 84 is recorded with assemblies having valid interference check results. Note that in the first exemplary embodiment the interference check result list 84 is generated at step 160 and temporarily stored in the memory 44. Note that configuration may be made such that the interference check result list 84 is pre-stored in the database 78, and at step 160 processing to delete all the assemblies from the interference check result list 84 is performed as the initialization processing.

FIG. 17 illustrates an example of an interference check result list 84. FIG. 17 illustrates an example of the interference check result list 84 displayed on the display device 46 as a table 86 of interference check results when the assembly Asy1 is designated as the highest level assembly of a display. The interference check result list 84 illustrated in FIG. 17 is an example in which, as assemblies with valid interference check results, the interference result data 38R written to all the assemblies subordinate to the assembly Asy1 are recorded. Namely, for the assembly Asy1, interference checks are performed between 6 pairs of objects (see FIG. 13), with a first object and a second object associated with each other and recorded as each of the object pairs.

Note that FIG. 18 illustrates an example of another interference check result list 84. FIG. 18 is an example of the interference check result list 84 displayed on the display device 46 as the table 86 of interference check results when the assembly Asy4-111 is designated as the highest level assembly. In FIG. 18, interference checks are performed for the assembly Asy4-111 between 2 pairs of objects (see FIG. 13), with a first object and a second object associated with each other and recorded as each of the object pairs.

At step 164 illustrated in FIG. 16, all of the assemblies subordinate to the highest level assembly designated at step 160 are extracted as display candidate assemblies. At the next step 166, one display candidate assembly out of the display candidate assemblies extracted at step 164 is designated as the target assembly. At the next step 168, determination is made as to whether or not the target assembly designated as the interference check result display candidate already has interference check result data.

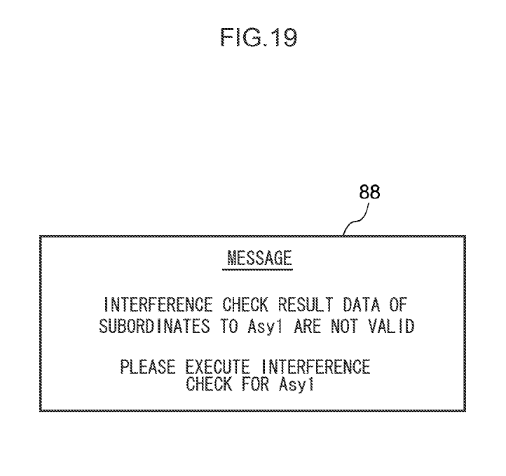

When negative determination is made at step 168, then at step 186, display data is displayed indicating that the interference check result is not valid (FIG. 19), and the current routine is ended.

FIG. 19 is an example of display data 88 representing that the interference check results are not valid FIG. 19 illustrates an example of display data for the assembly Asy1 designated as the highest level assembly indicating that the interference check result data is not valid. In addition to data indicating that the interference check result is not valid, the display data 88 illustrated in FIG. 19 also contains data prompting execution of an interference check.

However, when affirmative determination is made at step 168, determination is made that the interference result data 38R for the target assembly is valid. Namely, when there is the interference check result data 38 for the target assembly, the object data (object name and last edit time) are acquired at step 170 for all the objects one layer below the target assembly at the current point in time. At step 170, the latest object data is acquired based on the design data. Then at step 172, the object data (object name and last edit time) are acquired for all the objects one layer below the target assembly at the interference check time. At step 172, object data is acquired based on the attribute data of the assembly associated with the interference check time. At the next step 174, determination is made as to whether or not there is any discrepancy between the last edit time acquired at step 170 and the last edit time acquired at step 172.

For example, as illustrated in FIG. 9, when there is a discrepancy between the latest last edit time and the interference check time last edit time for the subordinate object assembly Asy4-111, then determination is made that the interference result data 38R of the assembly Asy4-111 is not valid. Namely, the subordinate object assembly Asy4-111 has a discrepancy between the last edit time of the latest object data 38Ja based on the design data, and the last edit time of the latest object data 38Jb based on attribute data of the assembly at interference check. Consequently, for the assembly Asy4-111, since there is a discrepancy between the last edit time of the part Prt5-1111 that is an object one layer below, the assembly Asy4-111 becomes a target assembly for which the interference check result is not valid.

When there is a discrepancy between the latest last edit time based on the design data and the last edit time at interference check time, affirmative determination is made at step 174, and processing proceeds to step 186. However, negative determination is made at step 174 when there is a match between the latest last edit time based on the design data and the last edit time at interference check time, then at step 176 the interference result data of the target assembly is added to the interference check result list. Processing to add to the interference check result list is processing to add interference result data expressing the interference check result, and to update the interference check result list 84. Namely, in a case in which the target assembly has valid interference check result data in which the last edit times of all of the objects match, then in order to display the interference result data 38R, the interference result data 38R of the target assembly is added to the interference check result list 84.

Next, in order to progress to processing for the next remaining assembly, at step 178 determination is made as to whether or not there is a remaining assembly for which validity determination processing has not yet been performed on the interference check result data for a display candidate assembly extracted at step 164. Negative determination is made at step 178 when validity determination processing has been completed for all the display candidate assemblies, and processing proceeds to step 180. At step 180, the table 86 is generated of the interference check results for displaying in the interference check result list 84, at the next step 182, the generated interference check result table 86 is displayed on the display device 46 and the current routine is ended. However, when affirmative determination is made at step 178, then at step 184, the next target assembly is designated and then processing proceeds to step 168.

Note that the processing by the interference check result output program 70 illustrated in FIG. 16 includes the processing of each of the assembly designation process 72, the validity check process 74 and the data output process 76. The assembly designation process 72 is processing to designate the highest level assembly to output the interference check result for. The processing of the assembly designation process 72 accordingly corresponds to the processing of step 160. The validity check process 74 is processing to check the validity of the interference check result data 38. Namely, it is processing to check the interference result data written to each of the assemblies subordinate to the designated highest level assembly and determine whether or not the interference result data is valid. The processing of the validity check process 74 corresponds to the processing of steps 162 to 178, and step 184. The data output process 76 is processing to output the interference result data for the designated highest level assembly. More specifically, when the interference result data of all the assemblies subordinate to the highest level assembly contained in the highest level assembly is valid, then the interference result data subordinate to the highest level assembly is output. However when not valid a message is displayed to inform that the current interference check result data is not valid. The processing of the data output process 76 corresponds to the processing of step 180 and step 182.

Moreover, the processing of step 160 is an example of processing in the assembly designation section 30 of the interference check result output section 14 illustrated in FIG. 1. The processing of steps 162 to 178 is an example of processing of the validity check section 32 illustrated in FIG. 1. The processing of steps 180, 182 is an example of processing of the data output section 34 illustrated in FIG. 1.

As explained above, in the present exemplary embodiment, determination is made as to whether or not the latest last edit time of the objects based on the design data matches the last edit time of the objects at interference check time, thereby determining the validity or non-validity of the interference check result data. Namely, it can be determined whether or not the object has been edited since executing the previous interference check, enabling determination can be made that the object has valid interference check result data when the last edit times match each other. This consequently enables determination as to whether or not the associated interference check result data is usable when interference check result data is associated with the object, and hence enables the reliability of the interference check results arising when the interference checks are executed to be raised.

Moreover, when the object has valid interference check result data, this accordingly enables the duration for executing interference checks to be shortened by using this valid object interference check result data.

For example, when executing a new interference check, interference checking is only performed for locations, namely between objects subordinate to an assembly, that have been influenced by editing of the design data since the last execution of the interference check. Moreover, this enables execution of a new interference check to be omitted at locations where there is no influence from editing of the design data, namely between subordinate assembly objects. The time saved by not executing interference checks enables the overall duration for executing interference checks to be shortened.

Moreover, in the first exemplary embodiment, determination is made that reliability of the interference check results is suspect when for example there is no match between the latest last edit time of the object and the last edit time at the interference check time. It thus suffices to execute interference checks for objects related to those objects that have suspicious reliability in their interference check results, rather than executing interference checks for the entire product. Namely, it is possible to execute interference checks individually for the objects with suspect reliability in interference check results. This accordingly enables the duration taken for execution of interference checks to be shortened in comparison to cases in which interference checks are executed for all the components contained in a product.

Moreover, in the first exemplary embodiment, the validity of the interference result data can be determined at the assembly unit level due to the interference check result being associated with (written to) each of the assemblies. Thus the interference check results can be checked for each of the assemblies when performing an interference check on a product. Moreover, this enables interference check result data to be obtained at a finer level for a product compared to cases in which interference check result data is acquired for the whole of a product from executing interference checks on the product as a whole, enabling determination to be made of the validity of fine level interference check result data.

Note that in the first exemplary embodiment, the last edit time may employ the editing end time when object design data is changed. For example, sometimes the last edit time is updated even though the design data has not been changed, such as when an object is merely looked at, or when the result of editing matched the design data prior to editing. Configuration may accordingly be made such that when a discrepancy is found between the latest last edit time of an object based on the design data and the last edit time of an object at interference check time, a comparison is made between the latest design data and the design data at the interference check time for the object with a discrepancy, and the comparison result employed to determine the importance of the last edit time discrepancy.

Moreover, in the first exemplary embodiment, explanation has been given of an example in which a HDD is employed for the storage section 16 and the storage section 54, however there is no limitation to a HDD, and for example a solid state drive (SDD) or serial flash memory may be employed therefor.

### Second Exemplary Embodiment

Explanation follows regarding a second exemplary embodiment. The second exemplary embodiment is the technology disclosed herein, applied to a case in which a portion of design data is used in another product. Note that in the second exemplary embodiment, since the configuration is substantially the same as that of the first exemplary embodiment, the same reference numerals are allocated to similar portions and detained explanation thereof omitted.

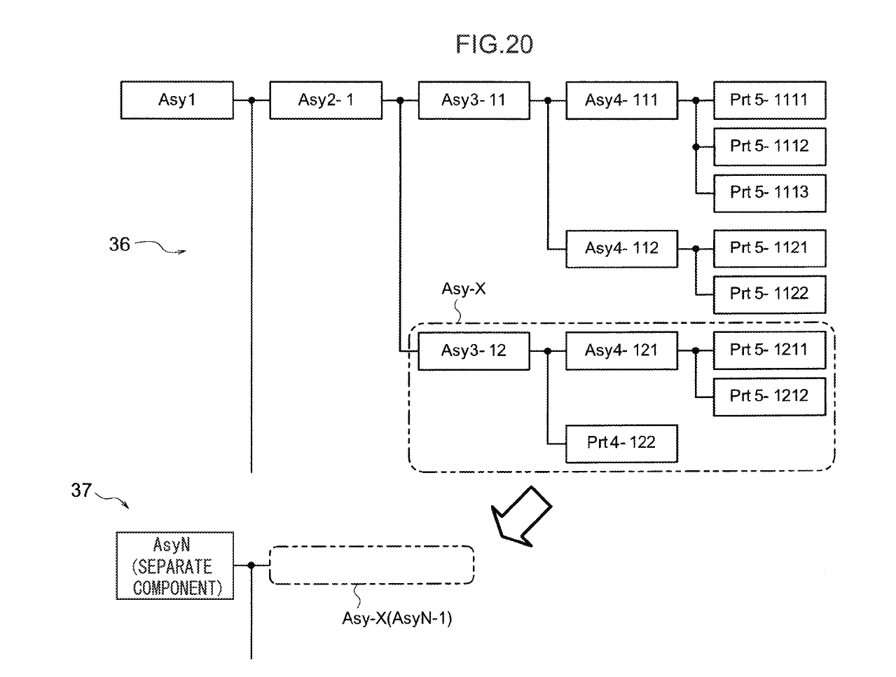

FIG. 20 illustrates an example of a procedure according to the second exemplary embodiment to use a portion of a product in another product. The product hierarchical structure 36 illustrated in FIG. 20 is part of the hierarchical structure 36 illustrated in FIG. 2. When all of the objects subordinate to the assembly Asy3-12 included in the hierarchical structure 36 are used in another product, for example, all of the objects subordinate to the assembly Asy3-12 become those of an assembly group Asy-X.

Another product is illustrated with the hierarchical structure 37 denoted assembly AsyN. The assembly Asy-X is connected subordinate to the assembly AsyN. Thus in another product, an interference check is executed with the assembly group Asy-X as an object of the assembly AsyN-1.

Interference result data is associated with the assembly group Asy-X. This thereby enables the assembly group Asy-X to be employed in another product, and enables the interference check result data of the assembly group Asy-X to be used as it is. Namely, when part of the design data is employed in the design of another apparatus, the interference check result data of employed part may also be transferred over into the design data of the other apparatus.

Note that in the second exemplary embodiment, explanation has been given of a case in which the interference check result data is used in another product, however this may also be applied to reusing the interference check result data within the same product.

As explained above, in the second exemplary embodiment, when part of the design data is employed in the design of another apparatus, the interference check result data of the employed part may be transferred over to the design data of the other apparatus, thereby enabling the number of target assemblies for interference checks in the employed part to be reduced. Moreover, transferring over the interference check result data to the design data of the other apparatus enables the time to execute interference checks in the other apparatus to be shortened. Consequently, according to the second exemplary embodiment, using the interference check result data in another product enables the execution time of interference checks to be shortened whilst raising the reliability of interference check result data.

Note that the interference check apparatus 10 described above may be implemented by a computer 40. There is no limitation to the above configuration, and obviously various improvements and modifications may be implemented within a range not departing from the spirit as described above.

Moreover, although explanation has been given above of cases in which the programs described are pre-stored (installed) in a storage section, there is no limitation thereto. For example, it is possible to provide data processing programs of technology disclosed herein in a format recorded on a recording medium such as a CD-ROM or a DVD.

One exemplary embodiment enables the reliability of interference check results arising from executing interference checks to be raised.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An interference check apparatus comprising:
a memory configured to store a latest edit time stamp related to at least one of a profile or a position for each of a plurality of components, and to store an edit time stamp for each of the plurality of components at an interference check execution time and to store interference check data representing an execution result of an interference check between components out of the plurality of components; and
a processor configured to execute a procedure, the procedure comprising:
determining a validity of the interference check data stored based on the latest edit time stamp of each of the plurality of components and the edit time stamp of the components when the interference check is executed contained in the interference check data.

2. The interference check apparatus of claim 1,
wherein, in the processor configured to execute the procedure of determining, the interference check data is valid for a component included in the interference check data when the latest edit time stamp matches the edit time stamp included in the interference check data.

3. The interference check apparatus of claim 2,
wherein, in the processor configured to execute the procedure, the procedure further comprises:
outputting a determination result of the validity of the interference check data that has been determined.

4. The interference check apparatus of claim 1, wherein:
the product is expressed by a hierarchical structure in which out of the plurality of components an assembly body of a combination of a plurality of the some of the components, or the component, or both, belong to a higher level assembly body; and
the memory stores the latest edit time stamp of the components belonging to the assembly body, and stores the edit time stamp of the component belonging to the assembly body at an interference check execution time and interference check data representing an execution result of an interference check between components belonging to the assembly body.

5. The interference check apparatus of claim 1, wherein
the product is expressed by a hierarchical structure in which out of the plurality of components an assembly body of a combination of a plurality of the some of the components, or the component, or both, belong to a higher level assembly; and
the memory stores the latest edit time stamp of the components belonging to the assembly body, stores the edit time stamp of the components belonging to the assembly body at an interference check execution time and stores interference check data representing an execution result of an interference check between components belonging to the assembly body associated with the assembly body.

6. The interference check apparatus of claim 1, wherein
the product is expressed by a hierarchical structure in which out of the plurality of components an assembly body of a combination of a plurality of the some of the components, or the component, or both, belong to a higher level assembly body; and
when the component or the assembly body is designated as the interference check target, the memory stores the edit time stamp when an interference check is executed for components belonging to an assembly body at a higher level than the designated component or the designated assembly body when the higher level assembly body is designated as the assembly body of the interference check target, and stores interference check data representing an execution result of an interference check between components belonging to the higher level assembly body.

7. An interference check method comprising:
by a processor, determining a validity of an interference check data based on a latest edit time stamp of each of a plurality of components and an edit time stamp of components when the interference check is executed contained in the interference check data,
wherein a memory stores a latest edit time stamp related to at least one of a profile or a position for each of the plurality of components, and store the edit time stamp for each of the plurality of components at an interference check execution time and store an interference check data representing an execution result of an interference check between components out of the plurality of components.

8. The interference check method of claim 7, wherein the determining a validity comprises:
determining for a component included in the interference check data that the interference check data is valid when the latest edit time stamp matches the edit time stamp included in the interference check data.

9. The interference check method of claim 8 further comprising:
outputting a determination result of the validity of the interference check data that has been determined.

10. The interference check method of claim 7, wherein:
the product is expressed by a hierarchical structure in which out of the plurality of components an assembly body of a combination of a plurality of the some of the components, or the component, or both, belong to a higher level assembly body; and
the memory stores the latest edit time stamp of the components belonging to the assembly body, and stores the edit time stamp of the component belonging to the assembly body at an interference check execution time and interference check data representing an execution result of an interference check between components belonging to the assembly body.

11. The interference check method of claim 7, wherein
the product is expressed by a hierarchical structure in which out of the plurality of components an assembly body of a combination of a plurality of the some of the components, or the component, or both, belong to a higher level assembly; and
the memory stores the latest edit time stamp of the components belonging to the assembly body, stores the edit time stamp of the components belonging to the assembly body at an interference check execution time and stores interference check data representing an execution result of an interference check between components belonging to the assembly body associated with the assembly body.

12. The interference check method of claim 7, wherein
the product is expressed by a hierarchical structure in which out of the plurality of components an assembly body of a combination of a plurality of the some of the components, or the component, or both, belong to a higher level assembly body; and
when the component or the assembly body is designated as the interference check target, the memory stores the edit time stamp when an interference check is executed for components belonging to an assembly body at a higher level than the designated component or the designated assembly body when the higher level assembly body is designated as the assembly body of the interference check target, and stores interference check data representing an execution result of an interference check between components belonging to the higher level assembly body.

13. A computer-readable, non-transitory medium having stored therein a program for causing a computer to execute an interference check process, the process comprising:
determining a validity of an interference check data based on a latest edit time stamp of each of a plurality of components and an edit time stamp of components when the interference check is executed contained in the interference check data,
wherein a memory stores a latest edit time stamp related to at least one of a profile or a position for each of the plurality of components, and stores the edit time stamp for each of the plurality of components at an interference check execution time and stores an interference check data representing an execution result of an interference check between components out of the plurality of components.

14. The computer-readable, non-transitory medium of claim 13, wherein the determining a validity comprises:
determining for a component included in the interference check data, the interference check data is valid when the latest edit time stamp matches the edit time stamp included in the interference check data.

15. The computer-readable, non-transitory medium of claim 14, wherein the interference check process further comprises:
outputting a determination result of the validity of the interference check data that has been determined.

16. The computer-readable, non-transitory medium of claim 13, wherein
the product is expressed by a hierarchical structure in which out of the plurality of components an assembly body of a combination of a plurality of the some of the components, or the component, or both, belong to a higher level assembly body; and
the memory stores the latest edit time stamp of the components belonging to the assembly body, and stores the edit time stamp of the component belonging to the assembly body at an interference check execution time and interference check data representing an execution result of an interference check between components belonging to the assembly body.

17. The computer-readable, non-transitory medium of claim 13, wherein:
the product is expressed by a hierarchical structure in which out of the plurality of components an assembly body of a combination of a plurality of the some of the components, or the component, or both, belong to a higher level assembly; and
the memory stores the latest edit time stamp of the components belonging to the assembly body, stores the edit time stamp of the components belonging to the assembly body at an interference check execution time and stores interference check data representing an execution result of an interference check between components belonging to the assembly body associated with the assembly body.

18. The computer-readable, non-transitory medium of claim 13, wherein
the product is expressed by a hierarchical structure in which out of the plurality of components an assembly body of a combination of a plurality of the some of the components, or the component, or both, belong to a higher level assembly body; and
when the component or the assembly body is designated as the interference check target, the memory stores the edit time stamp when an interference check is executed for components belonging to an assembly body at a higher level than the designated component or the designated assembly body when the higher level assembly body is designated as the assembly body of the interference check target, and stores interference check data representing an execution result of an interference check between components belonging to the higher level assembly body.
